(19) United States
(12) Patent Application Publication
(10) Pub. No.: US 2022/0405756 A1
(43) Pub. Date: Dec. 22, 2022

(54) METHOD AND SYSTEM FOR PIN LOGIN AUTHENTICATION

(71) Applicant: Lightspeed Commerce USA, Inc., New York, NY (US)

(72) Inventors: Alexandre Vallières-Lagacé, Quebec (CA); Alejandro Delgado Garcia, Montreal (CA); Sean Fraser, Montreal (CA)

(73) Assignee: Lightspeed Commerce USA, Inc., New York, NY (US)

(21) Appl. No.: 17/394,483

(22) Filed: Aug. 5, 2021

Related U.S. Application Data
(60) Provisional application No. 63/209,803, filed on Jun. 11, 2021.

(51) Int. Cl. G06Q 20/40; G06Q 20/38

(52) U.S. Cl. CPC G06Q 20/4012; G06Q 20/409; G06Q 20/3825

(57) ABSTRACT

A method and system is described for authenticating computer users using full login authentication to initialize a work session and then using an authentication by a PIN value when access is required in a fast moving workplace context.

### PRIORITY CLAIM

This is a utility application that claims the benefit of and priority to provisional application U.S. Pat. App. No. 63/209,803 filed on Jun. 11, 2021 which is incorporated by reference herein for all that it teaches.

### FIELD OF INVENTION AND BACKGROUND

The invention relates to user authentication where a device has a master account under which many subordinate users may operate, where the subordinate users need to login and out quickly on a periodic basis using a PIN or similar pass-code once the master account and their user accounts have been validated and logged in.

### SUMMARY

The system and method provide a streamlined process to authenticate users by using a PIN login. The typical PIN, or personal identification number, may be a 4 or 6 place alpha-numeric string or number that is easily remembered and easily keyed into a device. The number of digits may be lower or higher, depending on the level of security desired at the cost of convenience. However, “PIN” or “PIN value”, as used herein, may include a number of other quick login techniques, including a user inputting haptic pattern of motion, like sweeping a finger over a predetermined set of points displayed on a device screen, a fingerprint scan input into the device, the device capturing a face image using a device camera or other data items that can act as login codes that are easily and quickly input into the computer user interface in order to avoid the time consuming or error prone input of typing in full user credentials while operating in a fast-moving workplace context. The invention is described referring to PIN numbers typed into a device, but any PIN input value as described above representing the data input into the device in order to accomplish a fast user login authentication may be used. For example, in some retail locations, merchants employ restrictions on point of sale (POS) devices and other computer devices utilized by their employees and only allow approved devices in the physical store to access the merchant's accounts. Rather than cashiers or other personnel maintaining their own devices, managers login to the authorized device to first activate it for the day using the account credentials. Then, users, for example cashiers in a retail location, or waiters in a restaurant location (as non-limiting examples), login with their own credentials once and the cashiers are then granted the privilege of using their PIN value to access the device after the manager as opened the device for the day and they have also fully authenticated into the system. The manager authenticates each device at the start of the day and then locks the devices at the end of the day. At the end of the shift, the user logs out, which then cancels the PIN login privilege as well as logging out of any ancillary services that have been authenticated by the user. At the end of the day, the manager logs the device out.

In another embodiment, there is a register rule override function which requires age verification in the form of identification card scans in order to sell certain items where by law, sale is restricted. This can be overridden by a manager where the card is valid but not accepted by the system, due to military exemption laws, lack of a PDF417 barcode or grandfathering laws. The override can be accomplished by having the cashier populate a data record presented as a GUI interactive dialog box and typing in manually the card data (type, date of birth, expiry) and then having the manager approve the override of the transaction by the manager entering a PIN. The backend system in communication with the device can look up a user for the PIN and validate that they have the necessary rights to apply the override to the transaction, and further, determine that there is no change in authentication state of the original user.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 101 is first introduced and discussed with respect to FIG. 1).

FIG. 1: Exemplary flow

FIG. 2: Exemplary PIN flow

FIG. 3: Exemplary PIN flow

FIG. 4: Exemplary protocol design

FIG. 5: Exemplary protocol design

FIG. 6: Exemplary SAML Provider Approach

FIG. 7: Exemplary protocol design

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

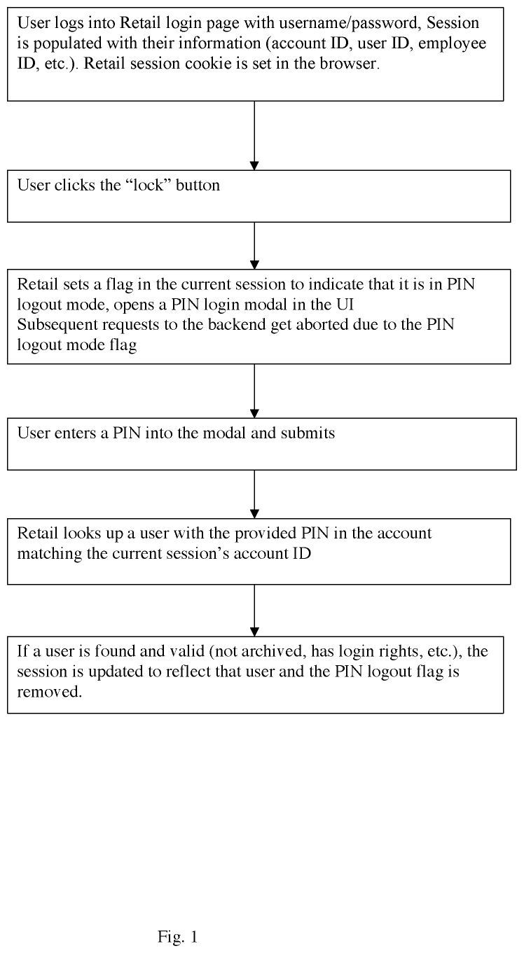

In an example, a point-of-sale system is comprised of a Retail computer process or service operating on a computer device, the user uses the device to log into a Retail login page with her username and password. Note that Retail refers to a point-of-sale process that operates on the system back-end but also includes component processes that are scripts and other code operating on the device that is in communication with the back-end using a data network. The components of the Retail process may include a browser operating on a device that displays webpages delivered from the back-end server and executes scripts comprising those pages. Further, the reference to the Retail process is exemplary and not intended to limit the claimed invention to point of sale processes because any process running on a computer system that requires periodic fast authentication by workers utilizing it may rely on the claimed invention. A session on the device is populated with the user's account ID, user ID, employee ID. FIG. 1. A Retail session cookie is set in the browser on the device. The session includes communication between the device and a backend server. The user then clicks the “lock” button. This allows the Retail process to set a flag in the current session to indicate that it is in PIN logout mode. As a result, subsequent requests by the Retail process to the backend server get aborted due to the PIN logout mode flag. The Retail process then opens a PIN login modal in the user interface presented to the user. The user then enters a PIN into the displayed login modal and clicks submit. The Retail process is able to lookup in a database a user identity by using the PIN provided and the account matching the current session account ID. If the user is found and validated (e.g., not archived, has login rights), the session is updated to reflect that user and the PIN logout flag is removed. As a result, the Retail process can make requests to the backend server, under the authority of the authenticated user.

In this embodiment, other processes or computer services that need to authenticate the user in order to secure the process may be blocked by the flag or browser cookie processes that are part of the Retail process authentication flow, thus rendering it not embeddable in these other processes or services. Connecting these other processes using an external authentication mechanism or functionality, like what Auth0 provides, is difficult. Auth0, for example, is a software service platform for authentication and authorization platform that can be called from an application as an external process. To log in, users are redirected to Auth0's customizable login page. Once the user logs in successfully, Auth0 redirects them back to the application, returning a token. For this reason, a current user has to be logged out of Auth0 and all other services such that setting the register to PIN-lock mode does not affect other logged-in service processes. When a user successfully submits their PIN, in order to be recognized by the other secure services they may need to re-authenticate through the Auth0 login page again for these other processes. This introduces difficulty in fast-moving workplace contexts. One example is a point-of-sale system operating in a restaurant. The manager may authenticate the point-of-sale device running the Retail process with the back end by going through the manager's authentication process, and each waiter may also authenticate once, but preferably, the different waiters can access that instance of the Retail process as they work by simply typing in their PIN and not undertaking the entire authentication process each time—a time consuming step in a busy restaurant environment. Therefore, there is a need for a point-of-sale process running on the system that permits PIN switching between users of a device or sharing access to the back-end process when the device or front-end Retail process has been authenticated with the back-end server once.

Back-End Process PIN Switching

In another embodiment, a PIN-authenticated user would only be able to access the Retail process running on the device and system. All other services would require the user to conduct full authentication. In this embodiment, other processes that operate user interfaces would have to stay coupled to the Retail process. That is, the authentication established for the Retail process is coupled to these other smaller or micro-front-end processes. In this embodiment, PIN switching between users operates with the Retail process so that the user-interface and logic surrounding PIN switching remains a part of Retail's codebase, but a simple call to the Auth0 logout endpoint is made as part of the PIN lock flow when switching processes. In this embodiment, there is no overlap with other services. Other processes that manage the workflow environment would need their own PIN switching implementation. This can be accomplished by having all back-end services that need to be accessible to the PIN switched user on the device be on the same root domain (e.g., lightspeedapp.com) and using wildcard cookies stored on the device to share some minimal state information between the apps that utilize the connection to the sub-domain. This embodiment is further comprised of a log-out process flow to maintain security because logging out Auth0 does not invalidate any local session running on the device. In this embodiment, an automatic logout chain process flow with all potential services operable on the device would prevent one PIN-verified user from being able to masquerade as another PIN user. When the device is locked, the device automatically logs out of the authentication service Auth0 and also logs out of the other services.

PIN Switching by Custom Database Connection

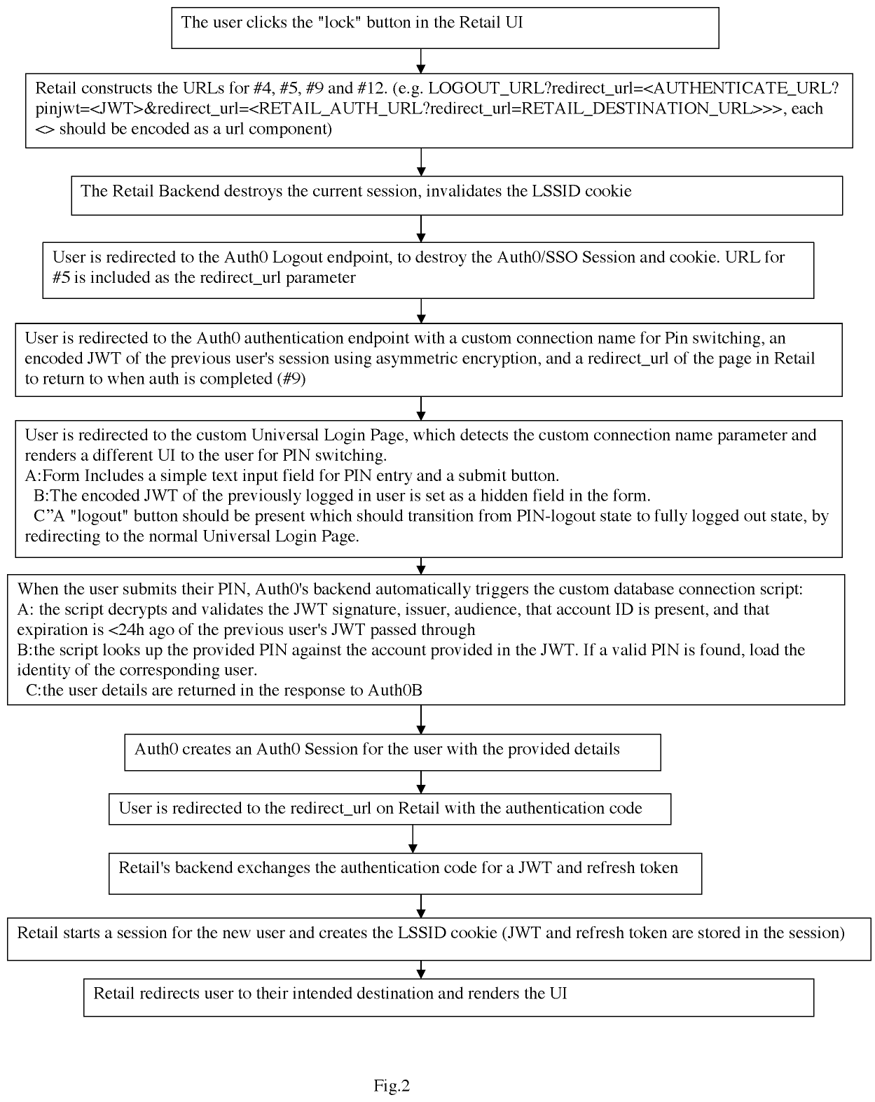

In an alternative embodiment, depicted in FIG. 2, a database is used to track login states. The database, referred to as a “Connection” is a database of users. The database is comprised of data records corresponding to the users. This provides a customizable set of custom database actions that allows actions made on that database to be enacted on a remote database system. This allows the Connection to be configured such that actions like Login, Create, VerifyCredentials, GetUser, Change Password, Delete are not conducted on the database of users at a single location—instead, the requests are transmitted on through data networks to a remote, centralized server running the database that acts as a source of authentication confirmation regarding user data records stored in the system. A request made for a Login call made on a process running on a device would trigger an action on the device running the Retail's process and Retail would answer back with a success or failure. In this embodiment, the centralized Connection database permits authentication by external processes that interface with the centralized system but require authentication of users of those external processes that seek information from the centralized system operating the Retail process, for example. The invention utilizes the benefits of these external, interfaced systems with its own source of truth for user storage in its systems. In this embodiment, an authentication process may be used, which may be an internal security process on the centralized server, or an external authentication service accessed through an API (application programming interface). One such service is the Auth0 service.

In this embodiment, prior to initiating the PIN flow, Retail users operating a device use a custom Universal Login Page or a Custom Login form hosted on Auth0 to initially login to the system with authentication, creating an Auth0 Session (SSO) and an application session (which may be labelled with a secure session identifier data value, for example, by an LSSID). The LSSID may be stored as a browser cookie on the device. Further, the session that is created may be represented by a data structure on the back-end server that is comprised of a user identifier and the corresponding LSSID and JSON Web Token (JWT). JSON web token or JWT) is an open standard (RFC 7519) that defines a compact and self-contained way for securely transmitting information between parties as a JSON object. The application session stores a JWT state value and refresh token associated with the user on the device. Other closely linked processes operating on the device or hosted on the back-end server, for example, hosted micro-frontends (which may be in the form of iframes) that the user visits while navigating the site would use Silent Authentication to verify the user each time the iframe is loaded.

An example PIN control flow works as follows.

1. The user clicks the “lock” button in the Retail process user interface operating on the device.
2. Retail process constructs the URLs for steps #4, #5, #9 and #12. (e.g. LOGOUT_URL redirect_url=<AUTHENTICATE_URL?
pinjwt=<JWT>&redirect_url=<RETAIL_AUTH_URL?redirect_url=RETAIL_DESTINATION_URL>>>, each < > should be encoded as a url component)
3. The Retail Backend process on the server destroys the current session and invalidates the LSSID cookie
4. The Retail process on the device directs the user to the main authentication process page, for example, the Auth0 Logout endpoint, and destroys any existing Auth0/SSO Session and cookie. URL for #5 is included as the redirect_URL parameter
5. The user is then redirected to the Auth0 authentication endpoint by means of a string representing a custom connection name for PIN switching, a signed JWT of the previous session (of the user) using, for example, asymmetric encryption, and a redirect_URL of the page in the Retail process to return to when authentication is completed (#9). In one embodiment, the JWT is digitally signed using an encryption process and that signature can be used to verify the JWT.
6. The user is then redirected to the custom Universal Login Page, which detects the custom connection name parameter in the HTTP package and renders a different user interface to the user for PIN switching.
a. This PIN interface is comprised of a simple text input field for PIN entry (for example, but may be a fingerprint reader, camera input, finger pattern reader process as described above) and a submit button.
b. The signed JWT of the previously logged in user is set as a hidden field in the form.
c. A “logout” button should be present which when actuated should transition the process from PIN-logout state to fully logged out state, by redirecting to the normal Universal Login Page.
   7. When the user submits their PIN, the authentication process, for example, the Auth0's backend, automatically triggers the custom database connection script.
a. the script decrypts and validates the JWT signature, issuer, audience, that the corresponding account ID is present in the database, and that expiration is less than some predetermined expiration time, for example, 24 hours after the previous user's JWT passed through
b. the script looks up the PIN input by the user against the account information provided in the corresponding JWT. If a valid PIN is found, the system loads the identity of the corresponding user.
c. the user details are returned in the response to authorization request, for example, Auth0
   8. Authorization process Auth0 creates an Auth0 Session for the user with the provided details
   9. User is redirected to the redirect_url on the Retail process with the authentication code
   10. The Retail process on the backend server exchanges the authentication code for a JWT and refresh token
   11. The Retail process on the device and back-end server starts a session for the new user and creates the LSSID cookie for the session, and the JWT and refresh token are stored in the session.
   12. The Retail process redirects new user to their intended destination and the Retail process on the device now renders the destination UI.

In the case where the PIN-logout state is maintained by having the user click the “lock” button, but the user leaves the Universal Login Page (for example, by close tab, close browser, or navigate to a different page) and then the user reopens either the Retail process or the universal login page, the user may be forced to log-in with their username and password because there will be no recollection by the device of the user's PIN-logout state. This may be avoided, when the custom Universal Login Page parses the parameters for PIN-logout state, (i.e. the encoded JWT), it will preferably store them in a memory location or data structure corresponding to the session, for example, local storage on the device or a session storage on the backend server. If the page is reloaded either directly or from a new attempt to load the Retail process, the page should automatically re-render the PIN login form instead of the normal login form by checking the stored parameters corresponding to the session to determine if the encoded JWT indicates a PIN logout state. If the user selects the user logout option the stored variables that indicate the PIN authentication status can be purged from the system. In this branch of the process, the Retail “logout” button then sends a custom parameter which tells the Universal Login Page to clear any previous cache. Alternatively at step #3, Retail process creates a temporary cookie which encodes the URL for #5, stored on the device either in the cookie body or in cache. If the user returns to the Retail process without having logged in using the full authentication, and before the cookie expires, the system can automatically redirect the user to the PIN login form. This requires the Retail process to purge that cache, or clear this cookie when the user triggers a full user logout from the Retail process (#6c). It also only permits new requests to Retail to maintain the PIN-logout state, and access to any other system will go to the standard login authentication form.

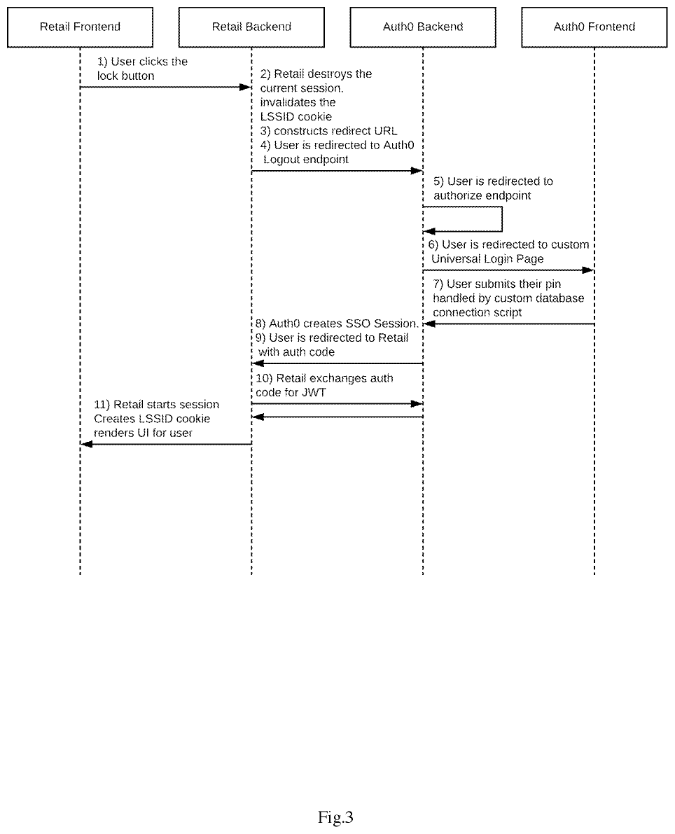

In this embodiment, the source of truth for the PIN database connection is shown in FIG. 3. In one option, PINs can be stored in an actual authentication service database. For example, the Auth0 database may be used so that the data record for a user in that authentication database also is comprised the PIN number data for that user. In one embodiment, the data record may be comprised of a user name, which may be username=hash of (accountID+PIN) and a password=PIN. However, approach requires ensuring uniqueness between users with the same name and that randomly select the same PIN. Alternatively, the user PINs can be stored in the data structures associated with the Retail process and the script calls out to that process as an identity Provider. In this approach, the Retail process could receive the account ID and PIN and validate them and return the ID of the user, which is then used to log into the authentication system, for example, Auth0. Preferably, a PIN switch logs the user in universally, so they are able to navigate to all applications and services. Preferably, the JWT value and other identifiers that are part of the redirect requests will be transmitted using HTTPS or some other encryption protocol to ensure security.

Proxy PIN Authentication

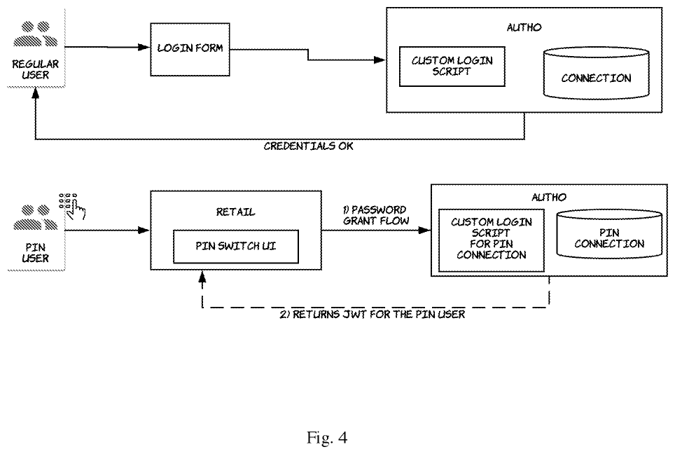

In yet another embodiment, a method for offering PIN Switching that is both convenient and secured, while at the same time leveraging an authentication process like Auth0 is employed. The result of this successful PIN switch is a JWT token that can work with any compatible service. In this approach, the Retail process does the PIN validation and signs a JWT that certifies its successful validation. In this embodiment, a different configuration on the Auth0 side is employed to ensure that “real” users and “PIN” users are not combined. This is so that there are different Login Scripts on Auth0 for a login authentication and a PIN entry. The PIN number will still be stored in a data structure controlled by the Retail process so that the Retail process is at liberty of hashing it or implementing other security changes without the need to update the login flow. This is demonstrated in FIG. 4 where the password grant flow is used to validate the PIN by:

1) a resource owner request with the following information:

connection=PIN connection

User name=account+UserID (e.g. PIN-user)

Password=valid JWT from Retail (proof that PIN was verified by the Retail process)

2) returns a JWT for the user with that PIN. The JWT should only be valid for the POS terminal that initiated the flow. Using it from another terminal should return an error.

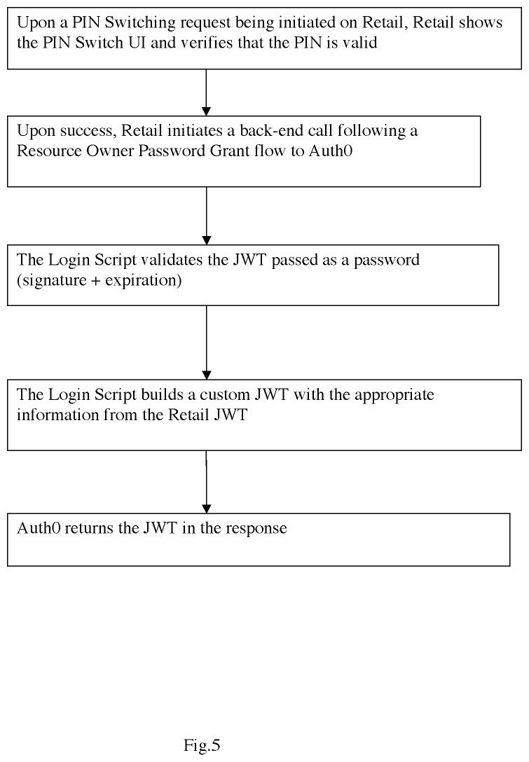

In this embodiment, the system performs several steps to conduct PIN switching:
1. Upon a PIN Switching request being initiated on the Retail process, Retail shows the PIN Switch user interface to the user, receives the PIN as input and verifies that the PIN is valid.
2. Upon validation, Retail initiates a back-end procedure call following a Resource Owner Password Grant flow to Auth0. This may include the JWT for the user for use on the POS terminal.
3. The Login Script validates the JWT passed as a password (signature+expiration)
4. The Login Script builds a second JWT with the appropriate information from the Retail JWT
5. Auth0 returns the second JWT in the response
This is further demonstrated in FIG. 5.
The Resource Owner Password Grant Request may be in this form:

```
curl --request POST \
  --url https://accounts.sbx.lightspeed.app/oauth/token \
  --header ‘content-type: application/x-www-form-urlencoded’ \
  --header ‘auth0-forwarded-for: 123.45.56.67’ \
  --data grant_type=http://auth0.com/oauth/grant-type/password-realm \
  --data audience=https://dev.lightspeedapis.com \
  --data realm=retail-pin-users
  --data client_id=CLIENT_ID \
  --data client_secret=CLIENT_SECRET \
  --data username=ls-retail-pin-user \
  --data password=<Retail Signed JWT> \
  --data ‘scope=offline_access openid profile email’
```

The Resource Owner Password Grant Response may be in this form:

“access_token”: “JWT_ACCESSS_TOKEN_VALUE”,
“refresh_token”: “REFRESH_TOKEN_VALUE”,
“id_token”: “JWT_ID_TOKEN_VALUE”,
“scope”: “openid profile email offline_access”,
“expires_in”: 86400,
“ _type”: “Bearer”

PIN Switching by Two-Way SAML/OIDC Provider

In this embodiment, PIN switching works by using Auth0 as a Security Assertion Markup Language (SAML) Service Provider and Identity Provider processes, with Retail acting as a federated identity provider process for PIN switch validation. SAML is an open standard for exchanging authentication and authorization data between parties, in particular, between an identity provider and a service provider. SAML is an XML-based markup language for security assertions (statements that service providers use to make access-control decisions). In this embodiment, the Retail process acts as a SAML Service Provider, the Auth0 process as an Identity Provider. And then the Auth0 acts as a Service Provider and the Retail PIN Login Screen process as the Identity Provider.

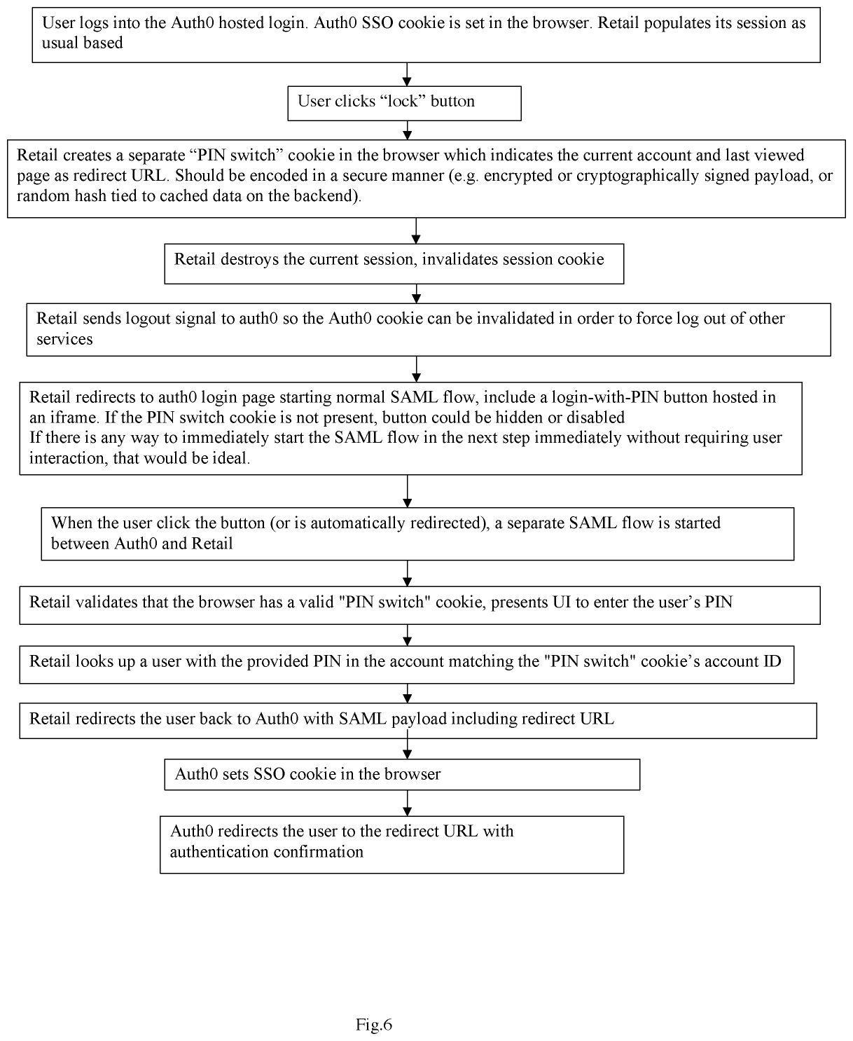

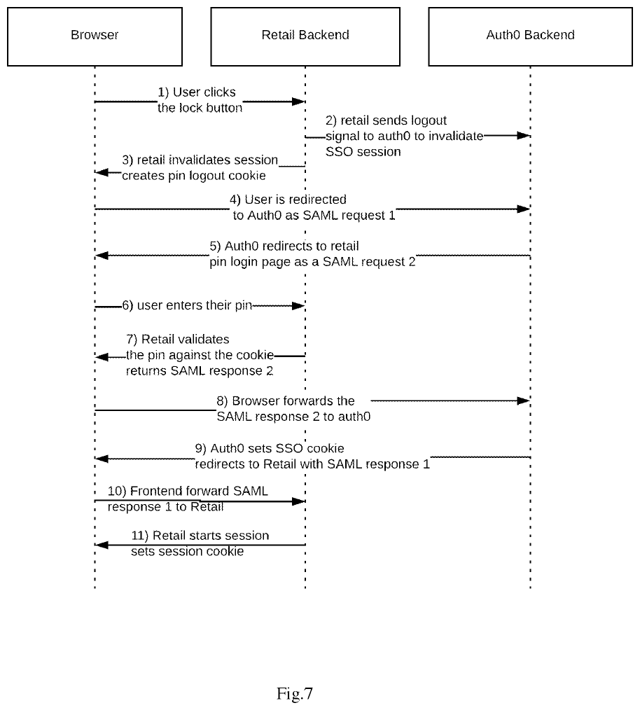

In this embodiment there are several steps to establish a PIN switching This is depicted in FIG. 6 and FIG. 7:

1. User logs into the authentication process, e.g. using the Auth0 hosted login. The process returns an Auth0 SSO cookie and JWT that is stored on the device, as a cookie set in the browser. The Retail process populates its session data structure using the received JWT as a component and a Retail session cookie is also stored and set in the browser.
2. User clicks the “lock” button on the user interface.
3. The Retail process creates a separate “PIN switch” cookie in the browser on the device which indicates the current account and last viewed page as a redirect_URL string. This cookie should be encoded in a secure manner (e.g. encrypted or cryptographically signed payload, or random hash tied to cached data on the backend).
4. Retail destroys the current session and invalidates the current session cookie
5. Retail sends logout signal to Auth0 so the Auth0 cookie can be invalidated in order to force log out of other services
6. Retail redirects to auth0 login page starting normal SAML flow, to include a login-with-PIN button hosted in an iframe. If the PIN switch cookie is not present, button is hidden or disabled.
Preferably, the SAML flow in the next step starts immediately without requiring user interaction.
7. When the user clicks the button (or is automatically redirected), a separate SAML flow is started between Auth0 and Retail
8. Retail validates that the browser has a valid “PIN switch” cookie, and renders on the device a user interface where the user can enter their PIN.
9. Retail looks up a user with the inputted PIN in the account matching the “PIN switch” cookie's account ID.
10. Retail redirects the user back to Auth0 with SAML payload including a redirect_URL
11. Auth0 sets SSO cookie in the browser
12. Auth0 redirects the user to the redirect_URL that includes as a payload the authentication confirmation
The process at the destination URL can then rely on the authentication confirmation and the SSO cookie data to provide access. Preferably, the authentication confirmation is encrypted to signed in order to promote security.

### Operating Environment:

The system is typically comprised of a central server or servers that are connected by a data network to a user's computer or device. The central server may be comprised of one or more computers connected to one or more mass storage devices. The precise architecture of the central server does not limit the claimed invention. Further, the user's computer may be a laptop or desktop type of personal computer. It can also be a cell phone, smart phone or other handheld device, including a tablet. The precise form factor of the user's computer does not limit the claimed invention. Examples of well-known computing systems, environments, and/or configurations that may be suitable for use with the invention include, but are not limited to, personal computers, server computers, hand-held computers, laptop or mobile computer or communications devices such as cell phones, smart phones, and PDA's, multiprocessor systems, microprocessor-based systems, set top boxes, programmable consumer electronics, network PCs, minicomputers, mainframe computers, distributed computing environments that include any of the above systems or devices, and the like. Indeed, the terms “computer,” “server,” and the like may be used interchangeably herein, and may refer to any of the above devices and systems.

The user environment may be housed in the central server or operatively connected to it remotely using a network. In one embodiment, the user's computer is omitted, and instead an equivalent computing functionality is provided that works on a server. In this case, a user would log into the server from another computer over a network and access the system through a user environment, and thereby access the functionality that would in other embodiments, operate on the user's computer. Further, the user may receive from and transmit data to the central server by means of the Internet, whereby the user accesses an account using an Internet web-browser and browser displays an interactive web page operatively connected to the central server. The server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user computer.

The Internet is a computer network that permits users operating a computer device to interact with computer servers located remotely and to view content that is delivered over the network from the remote servers to the computer device as data files or data streams. In one kind of protocol, the servers present webpages that are rendered on the user's device using a local program known as a browser. The browser receives one or more data files from the server that are displayed on the user's computer screen. The browser seeks those data files from a specific address, which is represented by an alphanumeric string called a Universal Resource Locator (URL). However, the webpage may contain components that are downloaded from a variety of URL's or IP addresses. In addition, the data received from a URL may be a data stream rather than a single file. In one embodiment, the browser interacts with a server using the URL using the HTTP or HTTPS protocol. In addition, the browser may send data to the server denoted by the URL by appending data that gets sent to the server into the HTTP or HTTPS request that is comprised of the URL. The server receiving the HTTP or HTTPS request may use the data payload contained in the request in order to process the request. A website is a collection of related URL's, typically all sharing the same root address or under the control of some entity. In one embodiment different regions of the simulated space displayed by the browser have different URL's. That is, the webpage encoding the simulated space can be a unitary data structure, but different URL's reference different locations in the data structure. The user computer can operate a program that receives from a remote server a data file that is passed to a program that interprets the data in the data file and commands the display device to present particular text, images, video, audio and other objects. In some embodiments, the remote server delivers a data file that is comprised of computer code that the browser program interprets, for example, scripts. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code. Alternatively, the data file returned may conform to a hyper text format like XML.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In one embodiment, a user's computer can run an application that causes the user's computer to transmit a stream of one or more data packets across a data network to a second computer, referred to here as a server. The server, in turn, may be connected to one or more mass data storage devices where the database is stored. In addition, the access of the website can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two respective remote computers to exchange information by means of digital network communication. As a result a data message can be one or more data packets transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network may operate with several levels, such that the user's computer is connected through a fire wall to one server, which routes communications to another server that executes the disclosed methods.

The server can execute a program that receives the transmitted packet and interpret the transmitted data packets in order to extract database query information or to process a request using data comprising the data packets. The server can then execute the remaining steps of the invention by means of accessing the mass storage devices to derive the desired result of the query or requested process. Alternatively, the server can transmit the query information or request processing to another computer that is connected to the mass storage devices, and that computer can execute the invention to derive the desired result. The result can then be transmitted back to the user's computer by means of another stream of one or more data packets appropriately addressed to the user's computer. In addition, the user's computer may obtain data from the server that is considered a website, that is, a collection of data files that when retrieved by the user's computer and rendered by a program running on the user's computer, displays on the display screen of the user's computer text, images, video and in some cases outputs audio. The access of the website can be by means of a client program running on a local computer that is connected over a computer network accessing a secure or public page on the server using an Internet browser or by means of running a dedicated application that interacts with the server, sometimes referred to as an “app.” The data messages may comprise a data file that may be an HTML document (or other hypertext formatted document file, like XML), commands sent between the remote computer and the server and a web-browser program or app running on the remote computer that interacts with the data received from the server. The command can be a hyper-link that causes the browser to request a new HTML document from another remote data network address location. The HTML can also have references that result in other code modules being called up and executed, for example, Flash, scripts or other code. The HTML file may also have code embedded in the file that is executed by the client program as an interpreter, in one embodiment, Javascript. As a result a data message can be a data packet transmitted from or received by a computer containing a destination network address, a destination process or application identifier, and data values or program code that can be parsed at the destination computer located at the destination network address by the destination application in order that the relevant data values or program code are extracted and used by the destination application.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, a relational database may be housed in one or more operatively connected servers operatively connected to computer memory, for example, disk drives. In yet another embodiment, the initialization of the relational database may be prepared on the set of servers and the interaction with the user's computer occur at a different place in the overall process.

The method described herein can be executed on a computer system, generally comprised of a central processing unit (CPU) that is operatively connected to a memory device, data input and output circuitry (TO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. In some embodiments, data stored in memory may be stored in the memory device, or an external mass data storage device like a disk drive. In yet other embodiments, the CPU may be running an operating system where storing a data set in memory is performed virtually, such that the data resides partially in a memory device and partially on the mass storage device. The CPU may perform logic comparisons of one or more of the data items stored in memory or in the cache memory of the CPU, or perform arithmetic operations on the data in order to make selections or determinations using such logical tests or arithmetic operations. The process flow may be altered as a result of such logical tests or arithmetic operations so as to select or determine the next step of a process. For example, the CPU may obtain two data values from memory and the logic in the CPU determine whether they are the same or not. Based on such Boolean logic result, the CPU then selects a first or a second location in memory as the location of the next step in the program execution. This type of program control flow may be used to program the CPU to determine data, or select a data from a set of data. The memory device can be any kind of data storage circuit or magnetic storage or optical device, including a hard disk, optical disk or solid state memory. The TO devices can include a display screen, loudspeakers, microphone and a movable mouse that indicate to the computer the relative location of a cursor position on the display and one or more buttons that can be actuated to indicate a command. The TO device may also be sensors that detect haptic motion, fingers scrolling or touching a screen, fingerprint scanners, cameras or other interactivity mechanisms.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades or brightness. The user interface may also display a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a two dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

In some instances, especially where the user computer is a mobile computing device used to access data through the network the network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), any form of 802.11.xx or Bluetooth.

Computer program logic implementing all or part of the functionality previously described herein may be embodied in various forms, including, but in no way limited to, a source code form, a computer executable form, scripts and various intermediate forms (e.g., forms generated by an assembler, compiler, linker, or locator.) Source code may include a series of computer program instructions implemented in any of various programming languages (e.g., an object code, an assembly language, or a high-level language such as Javascript, C, C++, JAVA, or HTML or scripting languages that are executed by Internet web-browsers) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, binary components that, when executed by the CPU, perform particular tasks or implement particular abstract data types and when running, may generate in computer memory or store on disk, various data structures. A data structure may be represented in the disclosure as a manner of organizing data, but is implemented by storing data values in computer memory in an organized way. Data structures may be comprised of nodes, each of which may be comprised of one or more elements, encoded into computer memory locations into which is stored one or more corresponding data values that are related to an item being represented by the node in the data structure. The collection of nodes may be organized in various ways, including by having one node in the data structure being comprised of a memory location wherein is stored the memory address value or other reference, or pointer, to another node in the same data structure. By means of the pointers, the relationship by and among the nodes in the data structure may be organized in a variety of topologies or forms, including, without limitation, lists, linked lists, trees and more generally, graphs. The relationship between nodes may be denoted in the specification by a line or arrow from a designated item or node to another designated item or node. A data structure may be stored on a mass storage device in the form of data records comprising a database, or as a flat, parsable file. The processes may load the flat file, parse it, and as a result of parsing the file, construct the respective data structure in memory. In other embodiment, the data structure is one or more relational tables stored on the mass storage device and organized as a relational database.

The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card, SD Card), or other memory device, for example a USB key. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., a disk in the form of shrink wrapped software product or a magnetic tape), preloaded with a computer system (e.g., on system ROM or fixed disk), or distributed from a server, website or electronic bulletin board or other communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention. Where the disclosure refers to matching or comparisons of numbers, values, or their calculation, these may be implemented by program logic by storing the data values in computer memory and the program logic fetching the stored data values in order to process them in the CPU in accordance with the specified logical process so as to execute the matching, comparison or calculation and storing the result back into computer memory or otherwise branching into another part of the program logic in dependence on such logical process result. The locations of the stored data or values may be organized in the form of a data structure.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

1.-42. (canceled)

43. A method for providing secure access to a first computer process operating on a computer system comprised of at least one server and at least one remote device comprising:
receiving at the at least one remote device comprising the computer system, a first user identifier data input into the at least one remote device by a first user;
executing a first verifying of the first user identifier data by using a first authentication process that automatically determines the logical condition that the first user identifier data is valid and corresponds to the first user and that the first user is authorized to access the first computer process;
in dependence on the first verifying step, storing on the computer system a data token representing a state of authorization of the first user;
rendering on a visual display comprising the at least one remote device a PIN login page;
receiving at the at least one remote device a PIN type user identification data by using the rendered PIN login page;
executing a second verifying of the PIN type user identification data by using a second authentication process that automatically determines the logical condition that the received PIN type user identification corresponds to the first user and that the data token represents a state of authorization of the first user; and
in dependence on the second verification, providing access to the first computer process operating on the remote device.

44. The method of claim 43 further comprising:
retrieving from data storage on the computer system a PIN authorization data value representing a logic state that the user is authorized to use PIN type user login procedures; and
in dependence on the logic state being valid, completing the executing the second verifying step.

45. The method of claim 43 further comprising:
receiving into the device data representing a logout from the first process by the first user; and
in dependence on the received logout data, resetting the token value to represent a state of no authorization.

46. The method of claim 43 further comprising:
in dependence on the first verifying step, locking the first authorization process by storing on the computer system a data value representing a logic state that the first authorization process is locked; and
in dependence on the second verifying step, unlocking the first authorization process by storing on the computer system a data value representing a logic state that the first authorization process is un-locked.

47. The method of claim 46 further comprising:
locking the second authorization process by storing on the computer system a data value representing a logic state that the second authorization process is locked; and
in dependence on the second verifying step, unlocking the second authorization process by storing on the computer system a data value representing a logic state that the second authorization process is un-locked.

48. The method of claim 47 where the first authorization process and second authorization process operate on the at least one servers by sharing a single root domain.

49. The method of claim 47 further comprising:
storing in a data memory comprising the computer system an at least one cookie data; and
using the at least one cookie data to share an at least one state information data between the first authorization process and the second authorization process.

50. The method of claim 47 further comprising:
detecting a logical state of logout of the first user, and in response to such detecting, automatically terminating the first authorization process and the second authorization process.

51. The method of claim 43 further comprising:
using an account data record stored on the computer system that corresponds to the first user to execute the first verifying step;
locking the first authentication process by storing on the computer system a data value representing a logic state that the first session is locked;
storing in a data memory comprising the computer system a constructed set of data representing at least one of a custom connection name, a JWT and a redirect URL of a page corresponding to the first authentication process to return to upon completion of the second authentication process;
redirecting a browser process operating on the device to an authentication service page corresponding to the first authentication process;
delivering to the authentication service page a data payload comprised of a customer connection name corresponding to the first user, the JWT and the redirect URL;
executing the second verifying step by verifying the input PIN type user identification data by executing a database script corresponding to the custom connection name; and
upon verification of the PIN value by the second verifying step, redirecting the browser to the redirect URL comprising the constructed data set.

52. The method of claim 51 further comprising executing a process called by the redirect URL and delivering to the executing authentication process a verification code data item.

53. The method of claim 51 where the JWT is signed.

54. The method of claim 51 where the step of verifying the input PIN value is comprised of validating the JWT.

55. The method of claim 54 where the step of validating the JWT is comprised of determining if the JWT has expired relative to a predetermined period of time.

56. The method of claim 51 where the second verifying step is comprised of:
using the JWT to determine an account information, said account information comprised of a target PIN data value; and
determining if the received PIN type user identification data matches the target PIN data value.

57. The method of claim 51 further comprising:
detecting in the computer system a logical condition that a full logout from the first process is requested by the first user; and
purging at least one of a cached data value or a stored cookie data value that represents a state of authentication of the first user.

58. The method of claim 51 further comprising:
storing in a data storage comprising the computer system a logic value representing a PIN-logout state;
reloading a page corresponding to the first authentication process;
retrieving by the first authentication process the stored logic value representing a PIN-logout state; and
automatically re-rendering the user interface for inputting a PIN type user identification data value into the device.

59. The method of claim 43 further comprising:
redirecting a browser process operating on the device to an external authentication service process;
rendering a page on a browser process executing on the device to accept a PIN type user identification data input from the user;
receiving as input from the user a PIN type user identification data through the rendered browser page;
validating that the received PIN type user identification data corresponds to the first user;
redirecting the browser process to the authentication service process using a data payload comprised of a redirect URL;
receiving from the authorization service a authentication confirmation logic value; and
redirecting the user to the redirect URL with a data payload comprised of the authentication confirmation logic value received from the authorization service.

60. The method of claim 59 where the PIN type user identification value is comprised of a data representing a current account of the user.

61. The method of claim 59 where the PIN type user identification value is comprised of a data representing the last viewed page as a redirect URL.

62. The method of claim 43 further comprising:
receiving into a SAML service provider process operating on a device comprising the computer system the first user identifier data value;
verifying the first user identifier data value by using an authentication process acting as an identity provider that is in data communication with the SAML service provider process;
receiving into a user interface process operating as an identity provider process, the PIN type user identification data; and
verifying the input PIN type user identification data by using an authentication process acting as a service provider that is in data communication with the user interface process operating as an identity provider process.

63. The method of claim 62 further comprising:
receiving into a device comprising the computer system a first user identifier data value;
verifying the first user identifier data value by using an authentication process;
receiving from the authentication process an SSO cookie and JWT that is stored on the device;
populating a session data structure using the received JWT as a component;
storing a current session cookie on the device;
storing on the computer system a data value representing a logic state that the current session is locked;
storing a PIN switch cookie comprised of data representing the user account and last viewed page as a redirect URL string;
destroying the current session;
invalidating the current session cookie;
transmitting to the authentication service a logout command;
invalidating the SSO cookie;
determining if the PIN switch cookie is valid;
in dependence on determining that the PIN switch cookie is valid, rendering on the device a user interface where the first user can enter a PIN type user identification data;
receiving through the user interface a PIN type user identification data;
verifying the received PIN type user identification data using the PIN switch cookie data;
redirecting the first user to the authentication service using an SAML protocol with a data payload comprised of the redirect URL string;
generating, by the authentication service, an SSO cookie corresponding to the first user; and
redirecting, by the authentication service, the first user to the location indicated by the redirect URL string with a data payload comprised of an authentication confirmation token received from the authentication service.

64. A computer system for providing secure access to a first user of a first computer process operating on the computer system, said computer comprised of at least one server and at least one remote device, and further comprised of a data storage device containing program data that when executed causes the computer to:
receive at the at least one remote device comprising the computer system, a first user identifier data input into the at least one remote device by the first user;
verify the first user identifier data by using a first authentication process that automatically determines the logical condition that the first user identifier data is valid and corresponds to the first user and that the first user is authorized to access the first computer process;
in dependence on the first verifying step, store on the computer system a data token representing a state of authorization of the first user;
render on a visual display comprising the at least one remote device a PIN login page;
receive at the at least one remote device a PIN type user identification data by using the rendered PIN login page;
execute a second verifying of the PIN type user identification data by using a second authentication process that automatically determines the logical condition that the received PIN type user identification corresponds to the first user and that the data token represents a state of authorization of the first user; and
in dependence on the second verification, provide access to the first computer process operating on the remote device.

65. The system of claim 64 where the computer code when executed further causes the computer system to:
retrieve from a data storage on the computer system a PIN authorization data value representing a logic state that the first user is authorized to use a PIN type of user login procedures; and
in dependence on the logic state being valid, complete the executing of the second verifying step.

66. The system of claim 64 where the computer code when executed further causes the computer system to:
receive into the device data representing a logout from the first process by the first user; and
in dependence on the received logout data, reset the token value to represent a state of no authorization.

67. The system of claim 64 where the computer code when executed further causes the computer system to:
in dependence on the first verifying step, lock the first authorization process by storing on the computer system a data value representing a logic state that the first authorization process is locked; and
in dependence on the second verifying step, unlock the first authorization process by storing on the computer system a data value representing a logic state that the first authorization process is un-locked.

68. The system of claim 64 where the computer code when executed further causes the computer system to:
lock the second authorization process by storing on the computer system a data value representing a logic state that the second authorization process is locked; and
in dependence on the second verifying step, unlock the second authorization process by storing on the computer system a data value representing a logic state that the second authorization process is un-locked.

69. The system of claim 68 where the first authorization process and second authorization process operate on the at least one servers by sharing a single root domain.

70. The system of claim 68 where the computer code when executed further causes the computer system to:
store in a data memory comprising the computer system an at least one cookie data; and
use the at least one cookie data to share an at least one state information data between the first authorization process and the second authorization process.

71. The system of claim 68 where the computer code when executed further causes the computer system to:
detect a logical state of logout of the first user, and in response to such detecting, automatically terminate the first authorization process and the second authorization process.

72. The system of claim 64 where the computer code when executed further causes the computer system to:
use an account data record stored on the computer system that corresponds to the first user to execute the first verifying step;
lock the first authentication process by storing on the computer system a data value representing a logic state that the first session is locked;
store in a data memory comprising the computer system a constructed set of data representing at least one of a custom connection name, a JWT and a redirect URL of a page corresponding to the first authentication process to return to upon completion of the second authentication process;
redirect a browser process operating on the device to an authentication service page corresponding to the first authentication process;
deliver to the authentication service page a data payload comprised of a customer connection name corresponding to the first user, the JWT and the redirect URL;
execute the second verifying step by verifying the input PIN type user identification data by executing a database script corresponding to the custom connection name; and
upon verification of the PIN value by the second verifying step, redirect the browser to the redirect URL comprising the constructed data set.

73. The system of claim 72 where the computer code when executed further causes the computer system to execute a process called by the redirect URL and deliver to the executing authentication process a verification code data item.

74. The system of claim 72 where the JWT is signed.

75. The system of claim 72 where the step of verifying the input PIN value is comprised of validating the JWT.

76. The system of claim 75 where the computer code when executed further causes the computer system to determine if the JWT has expired relative to a predetermined period of time.

77. The system of claim 72 where the computer code when executed further causes the computer system to:
use the JWT to determine an account information, said account information comprised of a target PIN data value; and
determine if the received PIN type user identification data matches the target PIN data value.

78. The system of claim 72 where the computer code when executed further causes the computer system to:
detect in the computer system a logical condition that a full logout from the first process is requested by the first user; and
purge at least one of a cached data value or a stored cookie data value that represents a state of authentication of the first user.

79. The system of claim 72 where the computer code when executed further causes the computer system to:
store in a data storage comprising the computer system a logic value representing a PIN-logout state;
reload a page corresponding to the first authentication process;
retrieve by the first authentication process the stored logic value representing a PIN-logout state; and
automatically re-render the user interface for inputting a PIN type user identification data value into the device.

80. The system of claim 64 where the computer code when executed further causes the computer system to:
redirect a browser process operating on the device to an external authentication service process;
render a page on a browser process executing on the device to accept a PIN type user identification data input from the user;
receive as input from the user a PIN type user identification data through the rendered browser page;
validate that the received PIN type user identification data corresponds to the first user;
redirect the browser process to the authentication service process using a data payload comprised of a redirect URL;
receive from the authorization service a authentication confirmation logic value; and
redirect the user to the redirect URL with a data payload comprised of the authentication confirmation logic value received from the authorization service.

81. The system of claim 80 where the PIN type user identification value is comprised of a data representing a current account of the user.

82. The system of claim 80 where the PIN type user identification value is comprised of a data representing the last viewed page as a redirect URL.

83. The system of claim 64 where the computer code when executed further causes the computer system to:
receive into a SAML service provider process operating on a device comprising the computer system the first user identifier data value;
verify the first user identifier data value by using an authentication process acting as an identity provider that is in data communication with the SAML service provider process;
receive into a user interface process operating as an identity provider process, the PIN type user identification data; and
verify the input PIN type user identification data by using an authentication process acting as a service provider that is in data communication with the user interface process operating as an identity provider process.

84. The system of claim 83 where the computer code when executed further causes the computer system to:
receive into a device comprising the computer system a first user identifier data value;
verify the first user identifier data value by using an authentication process;
receive from the authentication process an SSO cookie and JWT that is stored on the device.
populate a session data structure using the received JWT as a component;
store a current session cookie on the device;
store on the computer system a data value representing a logic state that the current session is locked;
store a PIN switch cookie comprised of data representing the user account and last viewed page as a redirect URL string;
destroy the current session;
invalidate the current session cookie;
transmit to the authentication service a logout command;
invalidate the SSO cookie;
determine if the PIN switch cookie is valid;
in dependence on determining that the PIN switch cookie is valid, render on the device a user interface where the first user can enter a PIN type user identification data;
receive through the user interface a PIN type user identification data;
verify the received PIN type user identification data using the PIN switch cookie data;
redirect the first user to the authentication service using an SAML protocol with a data payload comprised of the redirect URL string;
generate, by the authentication service, an SSO cookie corresponding to the first user; and
redirect, by the authentication service, the first user to the location indicated by the redirect URL string with a data payload comprised of an authentication confirmation token received from the authentication service.
